(19) United States
(12) Patent Application Publication
(10) Pub. No.: US 2025/0375913 A1
(43) Pub. Date: Dec. 11, 2025

(54) TECHNIQUE AND PROCESS FOR SEPARATING RUBBER FROM CORE BEFORE VULCANIZATION OF STRONG CONVEYOR BELT JOINT

(71) Applicants: TAIYUAN UNIVERSITY OF TECHNOLOGY, Taiyuan, Shanxi (CN); Yuncheng Vocational and Technical University, Yuncheng, Shanxi (CN)

(72) Inventors: Ziming KOU, Taiyuan (CN); Junxia LI, Taiyuan (CN); Yan PEI, Yuncheng (CN); Yandong WANG, Taiyuan (CN); Jun YANG, Taiyuan (CN); Haiqing WANG, Taiyuan (CN); Jiabao XUE, Taiyuan (CN)

(73) Assignees: TAIYUAN UNIVERSITY OF TECHNOLOGY, Taiyuan, Shanxi (CN); Yuncheng Vocational and Technical University, Yuncheng, Shanxi (CN)

(21) Appl. No.: 18/878,584

(22) PCT Filed: Dec. 13, 2022
(86) PCT No.: PCT/CN2022/138784

§ 371 Date: Dec. 23, 2024

(30) Foreign Application Priority Data
Jun. 27, 2022 (CN) 202210745115.8

(51) Int. Cl. B26D 7/26; B65G 15/36

(52) U.S. Cl. CPC B26D 7/2628; B65G 15/36

(57) ABSTRACT

A method for separating a steel wire rope core of a conveyor belt as disclosed in the embodiments of the present application includes the following steps: controlling a conveyor belt to move so as to make a conveyor belt joint move along a blade of a flat cutter; cutting off rubber layers on two sides of each steel wire rope core at the conveyor belt joint in a first direction; controlling the conveyor belt to move so as to make the conveyor belt joint move along a blade of a forming cutter; and cutting off the rubber layers between the steel wire rope cores at the conveyor belt joint in a second direction. The method for separating a steel wire rope core of a conveyor belt as provided in the embodiments of the present application is used for separating a steel wire rope core of a conveyor belt.

### CROSS-REFERENCE TO RELATED APPLICATIONS

This is a national stage of International Application No. PCT/CN2022/138784 filed on Dec. 13, 2022, which claims priority to Chinese Patent Application No. 202210745115.8, filed on Jun. 27, 2022. The disclosures of the above-referenced applications are hereby incorporated by reference in their entirety.

### TECHNICAL FIELD

Embodiments of the disclosure relates to a technique for separating a plurality of steel wire rope cores of a conveyor belt, and in particular to a method for separating a plurality of steel wire rope cores of a conveyor belt.

### BACKGROUND

A belt conveyor is an important device for transporting bulk materials. With the development of the belt conveyor towards a long distance and a large volume, a conveyor belt of the belt conveyor is generally provided with an inner core. The inner core of a common conveyor belt is provided with a plurality of steel wire ropes, and the conveyor belt with the inner core composed of the plurality of steel wire ropes are widely used because of its high strength and low elongation. For the conveyor belt with the long distance, a length of the conveyor belt is several kilometers or even tens of kilometers. When the conveyor belt is mounted, it is necessary to vulcanize and glue conveyor belts each having a short length, to allow a conveyor belt with a long length to be formed. In addition, in the daily use of the conveyor belt, it is inevitable that the conveyor belt may be damaged due to the fact that the conveyor belt is scratched by a hard object, etc. Thus, it is also necessary to replace a scratched location of the conveyor belt, and it is also necessary to perform a gluing of the conveyor belt. However, when the gluing of the conveyor belt is performed, it is necessary to separate a rubber layer from a plurality of steel wire rope cores at a joint of the conveyor belt.

In the related art, the separation of the plurality of steel wire rope cores located at the joint of the conveyor belt needs to sequentially cut off the rubber layer around each of the plurality of steel wire rope cores along the plurality of steel wire rope cores of the conveyor belt. When the conveyor belt contains a large number of steel wire rope cores, the separation of the plurality of steel wire rope cores of the conveyor belt from the rubber layer requires high labor intensity and leads to long time consumption.

### SUMMARY

In order to solve the above problems, embodiments of the disclosure provide a method for separating a plurality of steel wire rope cores of a conveyor belt, which has the following advantages. A rubber layer located at a joint of the conveyor belt may be effectively cut off, the operation efficiency is high, and the problems of the high labor intensity and the long time consumption caused by the separation of the plurality of steel wire rope cores located at the joint of the conveyor belt are solved.

In order to achieve the above objects, technical solutions of the embodiments of the disclosure are realized as follows.

The embodiments of the disclosure provide a method for separating a plurality of steel wire rope cores of a conveyor belt, which includes the following operations.

The conveyor belt is controlled to move to allow a joint of the conveyor belt to move along at least one flat cutter.

A rubber layer on each of two sides of each of the plurality of steel wire rope cores located at the joint of the conveyor belt is cut off along a first direction by the at least one flat cutter.

The conveyor belt is controlled to move to allow the joint of the conveyor belt to move along at least one forming cutter.

A rubber layer between the plurality of steel wire rope cores located at the joint of the conveyor belt is cut off along a second direction by the at least one forming cutter.

The first direction is a thickness direction of the conveyor belt, and the second direction is a width direction of the conveyor belt. A blade of the at least one flat cutter is provided as a linear type, and a blade of the at least one forming cutter is provided with a plurality of semicircular cutting edges. A spacing between every two adjacent semicircular cutting edges of the plurality of semicircular cutting edges is equal to a spacing between every two adjacent steel wire rope cores of the plurality of steel wire rope cores of the conveyor belt, and each of the blade of the at least one flat cutter and the blade of the at least one forming cutter has a dimension along the second direction greater than a width of the conveyor belt.

In the method for separating the plurality of steel wire rope cores of the conveyor belt according to the embodiments of the disclosure, each of the blade of the at least one flat cutter and the blade of the at least one forming cutter has a dimension along the width direction of the conveyor belt greater than the width of the conveyor belt. In this way, the rubber layer on each of the two sides of each of the plurality of steel wire rope cores of the conveyor belt is cut off once along the thickness direction of the conveyor belt by the at least one flat cutter, and the rubber layer between the plurality of steel wire rope cores of the conveyor belt is cut off once along the width direction of the conveyor belt by the at least one forming cutter. In this way, the operation efficiency of the separation of the plurality of steel wire rope cores of the conveyor belt is improved by the method for separating the plurality of steel wire rope cores of the conveyor belt according to the embodiments of the disclosure, thus the problems of the high labor intensity and the long time consumption caused by the separation of the plurality of steel wire rope cores located at the joint of the conveyor belt are solved.

In a possible implementation of the disclosure, before the conveyor belt is controlled to move to allow the joint of the conveyor belt to move along the at least one flat cutter, the method further includes a first preparation operation. The first preparation operation includes the following operations.

Two flat cutters are arranged symmetrically along the first direction at a target position.

A gap between the two flat cutters is adjusted to be greater than a thickness of the conveyor belt.

The conveyor belt is controlled to move to allow the joint of the conveyor belt to extend beyond the two flat cutters.

The gap between the two flat cutters is adjusted to be equal to a diameter of each of the plurality of steel wire rope cores.

In a possible implementation of the disclosure, the operation that the two flat cutters are arranged symmetrically along the first direction at the target position in the first preparation operation further includes the following operation.

A direction of extension of each of the two flat cutters is allowed to be parallel to the second direction.

In a possible implementation of the disclosure, the operation that the gap between the two flat cutters is adjusted to be equal to the diameter of each of the plurality of steel wire rope cores in the first preparation operation further includes the following operation.

A position of each of the two flat cutters is adjusted to allow the joint of the conveyor belt to move linearly along the blade of each of the two flat cutters.

In a possible implementation of the disclosure, the at least one flat cutter and the at least one forming cutter are arranged at a same target position. After the rubber layer on each of the two sides of each of the plurality of steel wire rope cores located at the joint of the conveyor belt is cut off along the first direction by the at least one flat cutter, the at least one flat cutter is replaced with the at least one forming cutter. Before the conveyor belt is controlled to move to allow the joint of the conveyor belt to move along the at least one forming cutter, the method further includes a second preparation operation. The second preparation operation includes the following operations.

The two flat cutters are removed at the target position.

Two forming cutters are arranged symmetrically along the first direction at the target position.

A gap between the two forming cutters is adjusted to be greater than the thickness of the conveyor belt.

The conveyor belt is controlled to move to allow the joint of the conveyor belt to extend beyond the two forming cutters.

The gap between the two forming cutters is adjusted to be equal to the diameter of each of the plurality of steel wire rope cores.

In a possible implementation of the disclosure, the operation that the conveyor belt is controlled to move includes the operation that the conveyor belt is controlled to move by a drum and a compression roller. The drum is rotatable about an axis of the drum, and the compression roller is rotatable about an axis of the compression roller and is rotatable around the roller between a position directly above the roller and a position directly below the roller.

In a possible implementation of the disclosure, before the conveyor belt is controlled to move to allow the joint of the conveyor belt to extend beyond the two flat cutters in the first preparation operation, the method further includes the following operations.

The compression roller is controlled to move to allow the compression roller to move to the position directly below the drum.

The joint of the conveyor belt is compressed between the drum and the compression roller.

The drum is controlled to rotate along a first rotation direction and the compression roller is controlled to rotate around the drum along the first rotation direction, to allow the conveyor belt to move toward the two flat cutters, and when the compression roller moves to the position directly above the drum, the compression roller is stopped to rotate around the drum.

In a possible implementation of the disclosure, the operation that the conveyor belt is controlled to move to allow the joint of the conveyor belt to move along the at least one flat cutter includes the following operations.

The compression roller is controlled to rotate along a second rotation direction, and when the compression roller moves to the position directly below the drum, the compression roller is stopped to rotate around the drum.

The drum is controlled to rotate along the second rotation direction.

In a possible implementation of the disclosure, before the conveyor belt is controlled to move to allow the joint of the conveyor belt to extend beyond the two forming cutters in the second preparation operation, the method further includes the following operation.

The drum is controlled to rotate along the first rotation direction and the compression roller is controlled to rotate around the drum along the first rotation direction, to allow the conveyor belt to move toward the two forming cutters, and when the compression roller moves to the position directly above the drum, the compression roller is stopped to rotate around the drum.

In a possible implementation of the disclosure, the operation that the conveyor belt is controlled to move to allow the joint of the conveyor belt to move along the at least one forming cutter includes the following operations.

The compression roller is controlled to rotate along the second rotation direction, and when the compression roller moves to the position directly below the drum, the compression roller is stopped to rotate around the drum.

The drum is controlled to rotate along the second rotation direction.

### BRIEF DESCRIPTION OF THE DRAWINGS

FIG. 1 is a flowchart of a method for separating a plurality of steel wire rope cores of a conveyor belt according to an embodiment of the disclosure.

FIG. 2 is three views of a flat cutter in a method for separating a plurality of steel wire rope cores of a conveyor belt according to an embodiment of the disclosure.

FIG. 3 is three views of a forming cutter in a method for separating a plurality of steel wire rope cores of a conveyor belt according to an embodiment of the disclosure.

FIG. 4 is a flowchart of a first preparation operation in a method for separating a plurality of steel wire rope cores of a conveyor belt according to an embodiment of the disclosure.

FIG. 5 is a flowchart of a second preparation operation in a method for separating a plurality of steel wire rope cores of a conveyor belt according to an embodiment of the disclosure.

FIG. 6A, FIG. 6B, FIG. 6C, FIG. 6D, FIG. 6E, FIG. 6F and FIG. 6G are schematic diagrams respectively illustrating an operation that a rubber layer of a conveyor belt is cut off by at least one flat cutter in a method for separating a plurality of steel wire rope cores of a conveyor belt according to an embodiment of the disclosure.

FIG. 7A, FIG. 7B, FIG. 7C and FIG. 7D are schematic diagrams respectively illustrating an operation that a rubber layer of a conveyor belt is cut off by at least one forming cutter in a method for separating a plurality of steel wire rope cores of a conveyor belt according to an embodiment of the disclosure.

FIG. 8 is a schematic process diagram illustrating an operation that a rubber layer of a conveyor belt is cut off by at least one forming cutter in a method for separating a plurality of steel wire rope cores of a conveyor belt according to an embodiment of the disclosure.

### LIST OF REFERENCE SYMBOLS

1-flat cutter; 2-forming cutter; 3-drum; 4-compression roller; 5-conveyor belt; 51-joint of conveyor belt; 52-steel wire rope core; A-first rotation direction; B-second rotation direction.

### DETAILED DESCRIPTION

In order to make objectives, technical solutions and advantages of the disclosure more clear, the specific technical solutions of the disclosure will be further described in detail below in combination with the drawings in the embodiments of the disclosure. The following embodiments are only intended to explain the disclosure, but are not intended to limit the scope of the disclosure.

In the embodiments of the disclosure, the terms “first” and “second” are only for purposes of description, and are not to be understood as indicating or implying relative importance or implicitly indicating the number of technical features indicated. Thus, the features defined as “first” and “second” may explicitly or implicitly include one or more of the features. In the description of the disclosure, the meaning of “a plurality of” is two or more, unless expressly defined and specified otherwise.

Furthermore, in the embodiments of the disclosure, the orientation terms such as “upper”, “lower”, “left” and “right” are defined with respect to the orientation of the components schematically arranged in the drawings. It should be understood that these orientation terms are relative concepts and are used for relative description and clarification. Thus, these orientation terms may change accordingly according to the change of the orientation of the components arranged in the drawings.

In the embodiments of the disclosure, unless expressly defined and specified otherwise, the term “connection” should be understood in a broad sense. For example, “connection” may be a fixed connection, a detachable connection, or an integral connection, and “connection” may be a direct connection, or an indirect connection through an intermediary.

In the embodiments of the disclosure, the terms “including”, “include” or any other variation thereof are intended to encompass non-exclusive inclusion, so that a process, a method, an object or a device that includes a set of elements includes not only those elements but also other elements that are not explicitly listed, or also includes elements inherent to such the process, the method, the object or the device. In the absence of further limitations, an element defined by the phrase “includes a . . . ” does not preclude the existence of another identical element in the process, the method, the object or the device that includes the element.

In the embodiments of the disclosure, the words such as “exemplary” or “for example” are used to mean an embodiment, an example or an illustration. Any embodiments or design solutions described as “exemplary” or “for example” in the embodiments of the disclosure should not be construed as being more preferred or superior to other embodiments or design solutions. More exactly, the use of the words such as “exemplary” or “for example” is intended to present related concepts in a specific manner.

Embodiments of the disclosure provide a method for separating a plurality of steel wire rope cores of a conveyor belt, and the separation of the plurality of steel wire rope cores of the conveyor belt is suitable for the situation that the vulcanization and gluing of a joint of the conveyor belt are performed. Before the vulcanization and gluing of the joint of the conveyor belt are performed, it is necessary to separate the plurality of steel wire rope cores located at the joint of the conveyor belt, to allow the plurality of steel wire rope cores of the conveyor belt to be exposed. Then the plurality of steel wire rope cores of the conveyor belt are engaged with each other, and finally the vulcanization and gluing of the joint of the conveyor belt are performed.

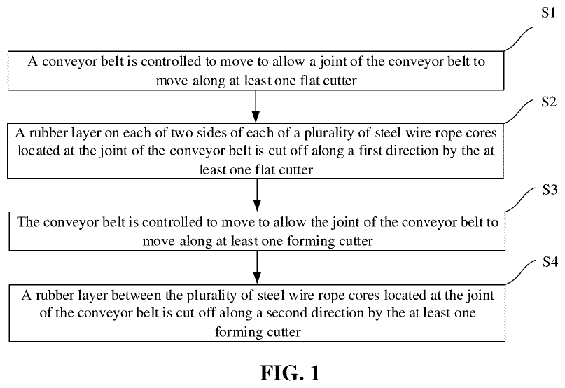

Specifically, with reference to FIG. 1 and FIG. 5, a method for separating a plurality of steel wire rope cores of a conveyor belt according to embodiments of the disclosure includes the following operations.

At S1, the conveyor belt 5 is controlled to move to allow a joint 51 of the conveyor belt to move along a blade of at least one flat cutter 1.

At S2, a rubber layer on each of two sides of each of the plurality of steel wire rope cores 52 located at the joint 51 of the conveyor belt is cut off along a first direction.

At S3, the conveyor belt 5 is controlled to move to allow the joint 51 of the conveyor belt to move along a blade of at least one forming cutter 2.

At S4, a rubber layer between the plurality of steel wire rope cores 52 located at the joint 51 of the conveyor belt is cut off along a second direction.

It should be noted that the first direction described above is a thickness direction of the conveyor belt 5, and the second direction described above is a width direction of the conveyor belt 5. The first direction described below is the thickness direction of the conveyor belt 5, and the second direction described below is the width direction of the conveyor belt 5, which will not be repeated herein.

In addition, the blade of the at least one flat cutter 1 in the operation S1 has a dimension along the second direction greater than a width of the conveyor belt 5. The blade of the at least one forming cutter 2 in the operation S3 has a dimension along the second direction greater than the width of the conveyor belt 5.

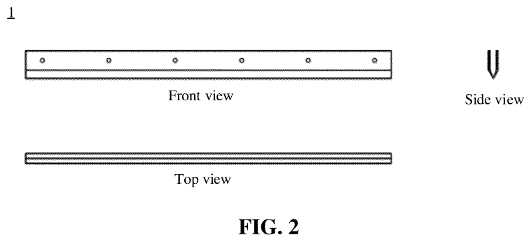

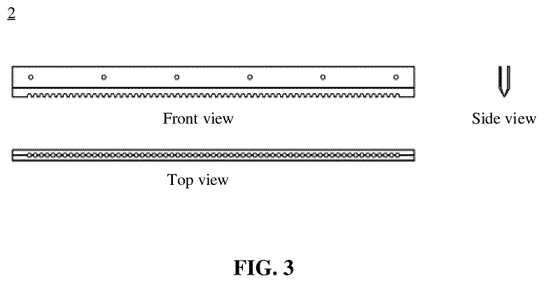

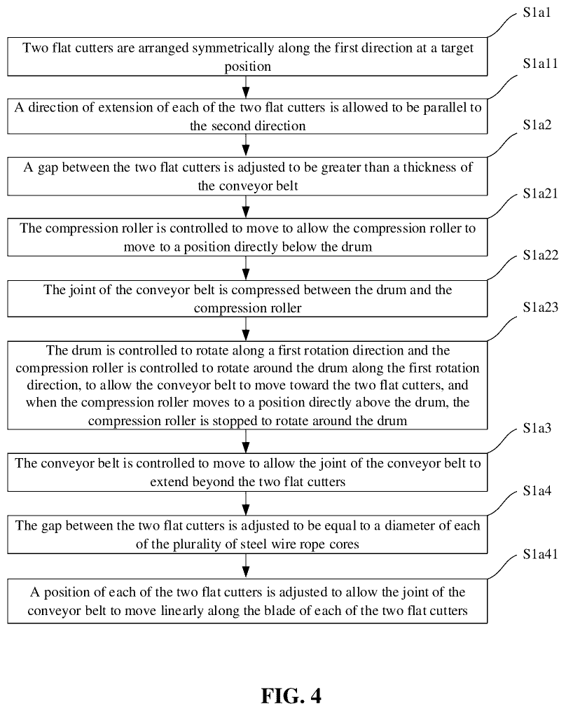

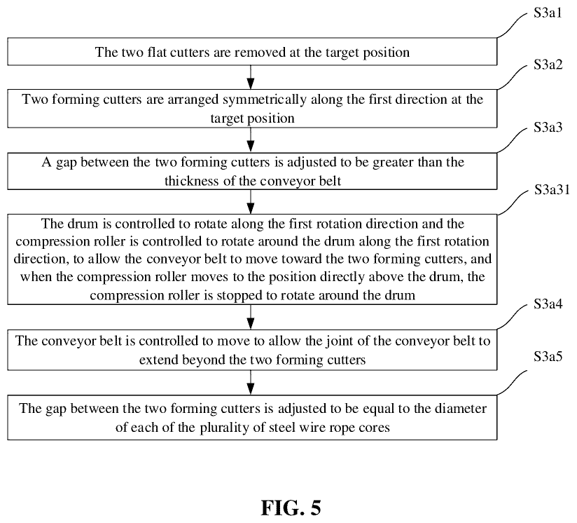

In some embodiments of the disclosure, with reference to FIG. 2, the blade of the at least one flat cutter 1 is provided as a linear type, and similar to a common cutter. The blade of the at least one flat cutter 1 is configured to cut off the rubber layer on each of two sides of each of the plurality of steel wire rope cores 52 of the conveyor belt along the thickness direction of the conveyor belt 5. In some embodiments of the disclosure, with reference to FIG. 3, the blade of the at least one forming cutter 2 is provided with a plurality of semicircular cutting edges, which are configured to cut off the rubber layer between the plurality of steel wire rope cores 52 of the conveyor belt along the width direction of the conveyor belt 5.

Furthermore, in the method for separating the plurality of steel wire rope cores 52 of the conveyor belt according to the disclosure, the conveyor belt 5 may be controlled to move by various methods. For example, a method for dragging an end of the conveyor belt 5 by a winch may be adopted to allow the joint 51 of the conveyor belt to move along the blade of the at least one flat cutter 1 or the blade of the at least one forming cutter 2. In this way, the at least one flat cutter 1 can cut off the rubber layer, and the at least one forming cutter 2 can cut off the rubber layer. In addition, the conveyor belt 5 may be controlled to move by a drum 3. Specifically, the conveyor belt 5 is arranged to be in tight contact with a surface of the drum 3, and the conveyor belt 5 is driven to move with the surface of the drum 3 by a friction force between the conveyor belt 5 and the drum 3, to allow the joint 51 of the conveyor belt to move along the blade of the at least one flat cutter 1 or the blade of the at least one forming cutter 2. In addition, in other embodiments of the disclosure, the conveyor belt 5 may be kept stationary, and the purpose of cutting off the rubber layer of the conveyor belt 5 may be achieved by controlling the at least one flat cutter 1 or the at least one forming cutter 2 to move. The embodiments of the disclosure are not limited thereto.

In this way, in the method for separating the plurality of steel wire rope cores 52 of the conveyor belt according to the embodiments of the disclosure, each of the at least one flat cutter 1 and the at least one forming cutter 2 has a dimension along the width direction of the conveyor belt 5 greater than the width of the conveyor belt 5. In this way, the rubber layer on each of the two sides of each of the plurality of steel wire rope cores 52 of the conveyor belt is cut off once along the thickness direction of the conveyor belt 5 by the at least one flat cutter 1, and the rubber layer between the plurality of steel wire rope cores 52 of the conveyor belt is cut off once along the width direction of the conveyor belt 5 by the at least one forming cutter 2. In this way, the operation efficiency of the separation of the plurality of steel wire rope cores 52 of the conveyor belt is improved by the method for separating the plurality of steel wire rope cores 52 of the conveyor belt according to the embodiments of the disclosure, thus the problems of the high labor intensity and the long time consumption caused by the separation of the plurality of steel wire rope cores 52 located at the joint 51 of the conveyor belt are solved.

In some embodiments of the disclosure, with reference to FIG. 4, before the operation S1 described above, the method further includes a first preparation operation S1a. Specifically, the first preparation operation Sla includes the following operations.

At S1a1, two flat cutters 1 are arranged symmetrically along the first direction at a target position.

At S1a2, a gap between the two flat cutters 1 is adjusted to be greater than a thickness of the conveyor belt.

At S1a3, the conveyor belt 5 is controlled to move to allow the joint 51 of the conveyor belt to extend beyond the two flat cutters 1.

At S1a4, the gap between the two flat cutters 1 is adjusted to be equal to a diameter of each of the plurality of steel wire rope cores 52.

It should be noted that the target position is a position where the two flat cutters 1 are arranged, and is also a reference position where the joint 51 of the conveyor belt moves. For example, in a case that the method for dragging the conveyor belt 5 by the winch is adopted to allow the conveyor belt 5 to move, the target position may be located in front of the joint 51 of the conveyor belt, and the two flat cutters 1 may be arranged in front of the joint 51 of the conveyor belt. In this way, the joint 51 of the conveyor belt may move along the two flat cutters 1, to allow the rubber layer of the joint 51 of the conveyor belt to be cut off by the two flat cutters 1. In a case that the drum 3 is adopted to allow the conveyor belt 5 to move, the target position may be a position on a movement path of the joint 51 of the conveyor belt. In this way, the joint 51 of the conveyor belt may move along the blade of each of the two flat cutters 1 during the movement of the joint 51 of the conveyor belt, to allow the rubber layer of the joint 51 of the conveyor belt to be cut off by the two flat cutters 1. Thus, the target position may be reasonably set with reference to the example described above.

Furthermore, the two flat cutters 1 are arranged symmetrically along the thickness direction of the conveyor belt 5. In an example, for the conveyor belt 5 horizontally arranged with respect to the position of each of the two flat cutters 1, the two flat cutters 1 may be arranged symmetrically on an upper side and a lower side of the conveyor belt 5. For the conveyor belt 5 arranged at other angles, the two flat cutters 1 may be arranged symmetrically along the thickness direction of the conveyor belt 5. The embodiments of the disclosure are not limited thereto.

Moreover, in order to allow the joint 51 of the conveyor belt to pass through the gap between the two flat cutters 1, it is also necessary to adjust the gap between the two flat cutters 1 to be greater than the thickness of the conveyor belt 5 in the operation S1a2. Specifically, in a case that the two flat cutters 1 are arranged on a fixing device, an adjusting device may be arranged to adjust the gap between the two flat cutters 1 conveniently. For example, the adjusting device may be arranged as follows. Each of the two flat cutters 1 may be provided with a bolt circular hole along the width direction of the conveyor belt 5, and the fixing device may be provided with a long strip hole. After the position of each of the two flat cutters 1 is adjusted, each of the two flat cutters 1 is fixed to the fixing device by a fastener, to allow the position of each of the two flat cutters 1 and the gap between the two flat cutters 1 to be adjusted within a length range of the long strip hole. In addition, an adjusting screw and an adjusting nut may serve as the adjusting device. Specifically, the adjusting screw may be arranged on each of the two flat cutters 1 along the thickness direction of the conveyor belt 5, and the adjusting nut may be arranged on the fixing device. A position of the adjusting screw with respect to the adjusting nut may be changed by the helical cooperation of the adjusting screw and the adjusting nut and by the rotation of the adjusting screw. Thus, the position of each of the two flat cutters 1 may be changed, and the gap between the two flat cutters 1 may be adjusted.

It should be noted that when the vulcanization and gluing of the joint 51 of the conveyor belt are performed, a length of a portion of the conveyor belt 5 where the plurality of steel wire rope cores 52 need to be separated is definite. In the present disclosure, the portion of the conveyor belt 5 where the plurality of steel wire rope cores 52 need to be separated is referred to as the joint 51 of the conveyor belt. A length of the joint 51 of the conveyor belt may be determined according to the specific material and the operating parameter of the conveyor belt 5. When a load of the conveyor belt 5 during operation of the conveyor belt 5 is high, the length of the joint 51 of the conveyor belt is also long. The embodiments of the disclosure are not limited thereto.

Then, the conveyor belt 5 is controlled to move to allow the joint 51 of the conveyor belt to fully extend beyond the two flat cutters 1. The joint 51 of the conveyor belt is controlled to move by the method for controlling the conveyor belt 5 to move described above, which will not be repeated herein.

At this time, the gap between the two flat cutters 1 is also greater than the thickness of the conveyor belt 5. In order to allow the rubber layer to be cut off by the two flat cutters 1, it is also necessary to adjust the gap between the two flat cutters 1, to allow the gap between the two flat cutters 1 to be equal to the diameter of each of the plurality of steel wire rope cores 52. The gap between the two flat cutters 1 may be adjusted by the method for adjusting the gap between the two flat cutters 1 described above, which will not be repeated herein.

In this way, since the two flat cutters 1 are arranged as described above, the rubber layer on each of two sides of each of the plurality of steel wire rope cores 52 of the conveyor belt may be cut off along the thickness direction of the conveyor belt 5 by one movement of the conveyor belt 5. Thus, the operation efficiency of the separation of the plurality of steel wire rope cores 52 of the conveyor belt by is further improved by the method for separating the plurality of steel wire rope cores 52 of the conveyor belt according to embodiments of the disclosure.

It should be noted that, in some embodiments of the disclosure, the operation S1a1 described above further includes the following operation. At S1a11, a direction of extension of each of the two flat cutters 1 is allowed to be parallel to the second direction. That is, the direction of extension of each of the two flat cutters 1 is allowed to be parallel to the width direction of the conveyor belt 5. In this way, the function of the two flat cutters 1 may be fully exerted. Compared with each of the two flat cutters 1 arranged obliquely along the width direction of the conveyor belt 5, in the method for separating the plurality of steel wire rope cores 52 of the conveyor belt according to embodiments of the disclosure, the direction of extension of each of the two flat cutters 1 is arranged to be parallel to the width direction of the conveyor belt 5. In this way, a length of each of the two flat cutters 1 may be reduced, and the manufacturing cost of each of the two flat cutters 1 may be saved.

In addition, in some embodiments of the disclosure, the operation S1a4, in addition to the operation that the gap between the two flat cutters 1 is adjusted, further includes the following operation. At S1a41, the position of each of the two flat cutters 1 is adjusted to allow the joint 51 of the conveyor belt to move linearly along the blade of each of the two flat cutters 1. In an example, in a case that the method for dragging the conveyor belt 5 by the winch is adopted to allow the conveyor belt 5 to move, the conveyor belt 5 is configured to move linearly. If each of the two flat cutters 1 is arranged at a position which is not located on a straight line of the movement trajectory of the conveyor belt 5, the movement trajectory of the conveyor belt 5 at each of the two flat cutters 1 may be bent by an angle. In this way, during the movement of the conveyor belt 5, the plurality of steel wire rope cores 52 of the conveyor belt are easily cut by the two flat cutters 1, which may cause the damage of the plurality of steel wire rope cores 52 of the conveyor belt. Moreover, in this way, each of the two flat cutters 1 is subjected to a load away from a center of the angle, which may increase the force strength of the two flat cutters 1 and may reduce the service life of the two flat cutters 1. In a case that the drum 3 is adopted to allow the conveyor belt 5 to move, the position of each of the two flat cutters 1 shall be adjusted, and each of the two flat cutters 1 is arranged on a tangent line of a tangent position of the conveyor belt 5 and the drum 3. Thus, the damage of the plurality of steel wire rope cores 52 of the conveyor belt by the two flat cutters 1 may be avoided, and the service life of the two flat cutters 1 may be increased.

In some embodiments of the disclosure, the at least one flat cutter 1 and the at least one forming cutter 2 may be arranged in series, for example, the at least one flat cutter 1 is arranged in front of the at least one forming cutter 2. In this way, during the movement of the conveyor belt 5, first, the rubber layer on each of two sides of each of the plurality of steel wire rope cores 52 located at the joint 51 of the conveyor belt is cut off along the thickness direction of the conveyor belt 5 by the at least one flat cutter 1, and then the rubber layer between the plurality of steel wire rope cores 52 located at the joint 51 of the conveyor belt is cut off along the width direction of the conveyor belt 5 by the at least one forming cutter 2. However, for the conveyor belt 5, the gluing between the plurality of steel wire rope cores 52 of the conveyor belt and the rubber layer is very strong. When the plurality of steel wire rope cores 52 located at the joint 51 of the conveyor belt are separated, the power for driving the conveyor belt 5 to move is very high. If the at least one flat cutter 1 and the at least one forming cutter 2 are arranged in series, a selection range of a driving device for driving the conveyor belt 5 to move is very small, and even a suitable driving device may not be found.

Therefore, in some embodiments of the disclosure, first, the at least one flat cutter 1 is arranged at the target position. After the rubber layer located at the joint 51 of the conveyor belt is cut off by the at least one flat cutter 1, the at least one flat cutter 1 is removed. Then the at least one forming cutter 2 is arranged at the same target position. In this way, the purpose of separating the plurality of steel wire rope cores 52 of the conveyor belt by the at least one flat cutter 1 and the at least one forming cutter 2 may be achieved by controlling the conveyor belt 5 to perform a repetitive movement.

Therefore, in some embodiments of the disclosure, before the operation S3 described above, the method further includes a second preparation operation S3a. Specifically, with reference to FIG. 5, the second preparation operation S3a includes the following operations.

At S3a1, the two flat cutters 1 are removed at the target position.

At S3a2, two forming cutters 2 are arranged symmetrically along the first direction at the target position.

At S3a3, a gap between the two forming cutters 2 is adjusted to be greater than the thickness of the conveyor belt 5.

At S3a4, the conveyor belt 5 is controlled to move to allow the joint 51 of the conveyor belt to extend beyond the two forming cutters 2.

At S3a5, the gap between the two forming cutters 2 is adjusted to be equal to the diameter of each of the plurality of steel wire rope cores 52.

In an example, the two flat cutters 1 and the two forming cutters 2 are arranged to be detachably connected to the fixing device. When the two flat cutters 1 need to be used, the two flat cutters 1 are mounted on the fixing device. When the two forming cutters 2 need to be used, the two flat cutters 1 are removed, and then the two forming cutters 2 are mounted on the fixing device. In this way, the adaptability of the method for separating the plurality of steel wire rope cores 52 of the conveyor belt according to embodiments of the disclosure may be improved.

After the two flat cutters 1 are removed at the target position, the two forming cutters 2 are arranged symmetrically along the first direction at the target position. Herein, the two forming cutters 2 may be arranged with reference to the arrangement of the two flat cutters 1 described above, which will not be repeated herein.

Then, the gap between the two forming cutters 2 is adjusted to allow the gap between the two forming cutters 2 to be greater than the thickness of the conveyor belt 5. In this way, the conveyor belt 5 may move through the gap between the two forming cutters 2.

Further, the conveyor belt 5 is controlled to move to allow the joint 51 of the conveyor belt to extend beyond the two forming cutters 2.

Finally, the gap between the two forming cutters 2 is adjusted again to allow blades of the two forming cutters 2 to be in contact with each other. Each of the plurality of steel wire rope cores 52 of the conveyor belt is snapped into a respective one of the plurality of semicircular cutting edges of each of the two forming cutters 2.

The operation S3 and operation S4 are further performed to allow the separation of the plurality of steel wire rope cores 52 located at the joint 51 of the conveyor belt to be completed.

Compared with a case that the winch or other means is adopted to allow the conveyor belt 5 to move, the conveyor belt 5 is driven to move by the drum 3, which may save the movement space of the conveyor belt 5 and may control the movement direction of the conveyor belt 5 easily. Therefore, in some embodiments of the disclosure, the conveyor belt 5 may be controlled to move by the drum 3. Moreover, in order to allow the conveyor belt 5 to be in tight contact with the surface of the drum 3, a compression roller 4 is also arranged to assist the drum 3, to control the movement of the conveyor belt 5. Since a gap between the compression roller 4 and the drum 3 is slightly less than the thickness of the conveyor belt 5, the conveyor belt 5 may be pressed against the surface of the drum 3 by the compression roller 4. Thus, the friction force between the conveyor belt 5 and the drum 3 may be increased, and when the conveyor belt 5 is driven to move by the drum 3, the conveyor belt 5 may be prevented from slipping.

It should be noted that the drum 3 is rotatable about an axis of the drum 3, and a drive device may be arranged and configured to drive the drum 3 rotate about the axis of the drum 3. For example, a motor may be arranged and configured to drive the drum 3 to rotate. Generally speaking, a general motor has the characteristics of a high speed and a low torque. However, when the plurality of steel wire rope cores 52 of the conveyor belt 5 are separated, a high torque is required. Therefore, a reduction gearbox may be arranged between the motor and the drum 3, to allow a rotational speed output by the reduction gearbox to be reduced and to allow a torque to be increased. In addition, the compression roller 4 is rotatable about an axis of the compression roller 4, and the compression roller 4 is rotatable about the drum 3. In an example, a further motor may be arranged and configured to drive the compression roller 4 to rotate about the drum 3. Since the movement trajectory of the compression roller 4 is an arc extending along an outer edge of the drum 3, a gear may be arranged between the motor and the compression roller 4, to allow the compression roller 4 to be rotated about the drum 3.

Therefore, before the operation S1a3 in the first preparation operation S1 described above, the method further includes the following operations.

At S1a21, the compression roller 4 is controlled to move to allow the compression roller 4 to move to a position directly below the drum 3.

At S1a22, the joint 51 of the conveyor belt is compressed between the drum 3 and the compression roller 4.

At S1a23, the drum 3 is controlled to rotate along a first rotation direction A and the compression roller 4 is controlled to rotate around the drum 3 along the first rotation direction A, to allow the conveyor belt 5 to move toward the two flat cutters 1, and when the compression roller 4 moves to a position directly above the drum 3, the compression roller 4 is stopped to rotate around the drum 3.

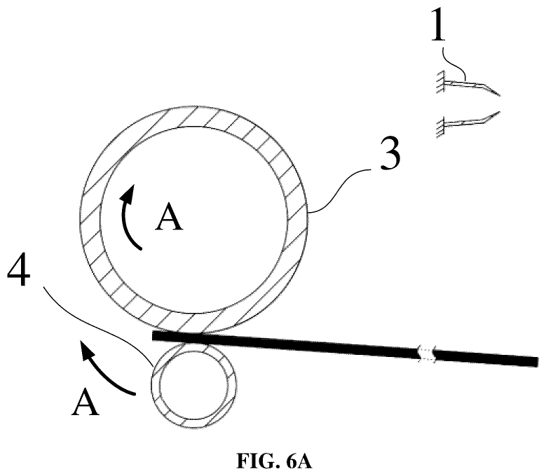

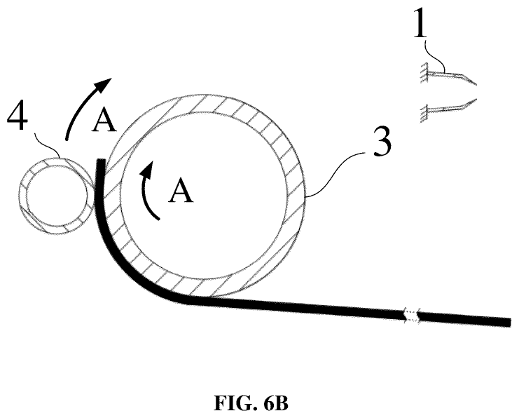

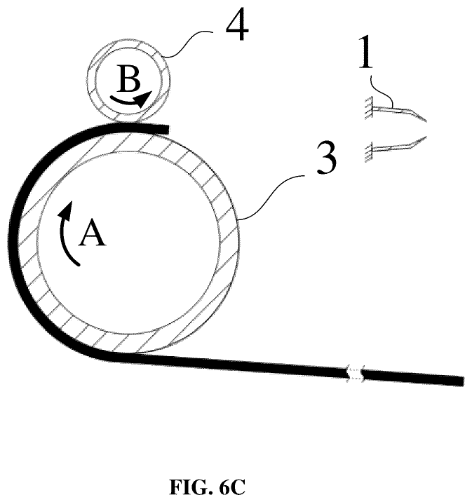

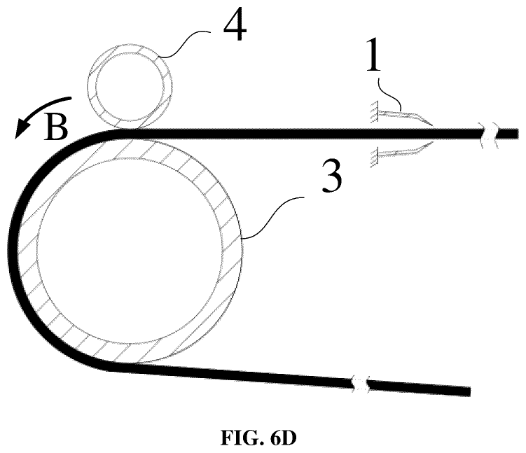

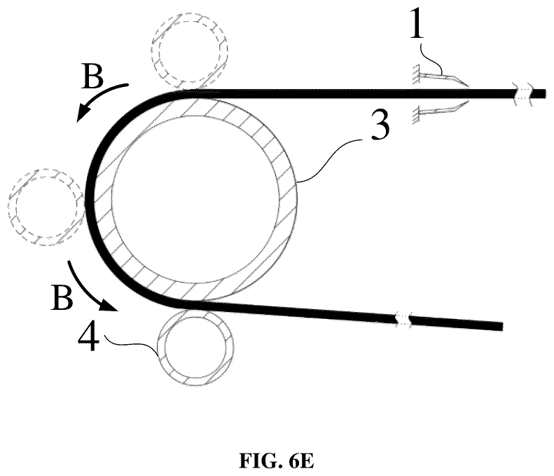

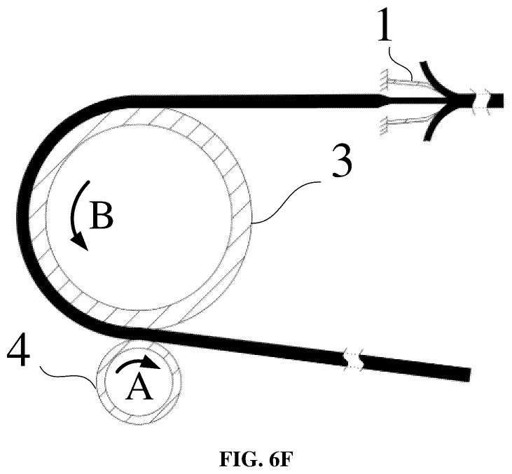

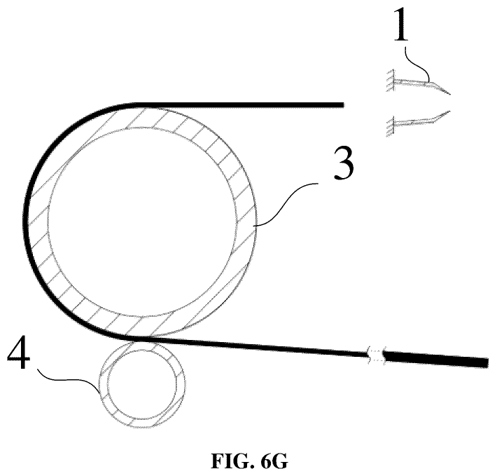

Specifically, in some embodiments of the disclosure, in an initial state in which the conveyor belt 5 is controlled to move by the drum 3, the conveyor belt 5 is arranged below the drum 3. With reference to FIG. 6A, FIG. 6B, FIG. 6C, FIG. 6D, FIG. 6E, FIG. 6F and FIG. 6G, accordingly, it is also necessary to control the compression roller 4 to move to allow the compression roller 4 to move to the position directly below the drum 3. In an example, the motor described above may be configured to drive the compression roller 4 to rotate. Moreover, a direction of movement of the compression roller 4 about the drum 3 may be changed by adjusting a rotation direction of the motor configured to drive the compression roller 4, to allow the compression roller 4 to be rotated between the position directly above the roller 3 and the position directly below the roller 3.

After the compression roller 4 moves to the position directly below the drum 3, the joint 51 of the conveyor belt is compressed between the drum 3 and the compression roller 4. As shown in FIG. 6A, since a gap between the compression roller 4 and the drum 3 is slightly less than the thickness of the conveyor belt 5, and since the pressure applied to the conveyor belt 5 by the compression roller 4 allows the friction force between the conveyor belt 5 and the surface of the drum 3 to be increased, the joint 51 of the conveyor belt may move with the rotation of the drum 3. When the drum 3 and the compression roller 4 are rotated towards the two flat cutters along a direction shown in FIG. 6A, the conveyor belt 5 may be driven to move towards the two flat cutters. In an example, as shown in FIG. 6A, the first rotation direction A is a clockwise direction.

The drum 3 is controlled to rotate along the first rotation direction A and the compression roller 4 is controlled to rotate around the drum 3 along the first rotation direction A, to allow the conveyor belt 5 to move toward the two flat cutters 1. In an example, FIG. 6B shows an intermediate state in which the drum 3 and the compression roller 4 move along the first rotation direction A. Then the drum 3 and the compression roller 4 are controlled to continue to move along the first rotation direction A to reach a state as shown in FIG. 6C. The compression roller 4 is stopped to rotate around the drum 3 when the compression roller 4 moves to the position directly above the drum 3. Since the compression roller 4 is rotatable about the axis of the compression roller 4, the compression roller 4 rotates about its axis with the movement of the conveyor belt 5. In this way, a static friction between the compression roller 4 and the conveyor belt 5 may be avoided, thus a friction force between the conveyor belt 5 and the compression roller 4 may be reduced, and the damage of the conveyor belt 5 by the compression roller 4 may be avoided. It should be noted that the drum 3 is controlled to continue to move along the first rotation direction A to reach a state as shown in FIG. 6D, to allow the joint 51 of the conveyor belt to extend beyond the two flat cutters 1.

In a case that the conveyor belt 5 is controlled to move by the drum 3 as described above, in some embodiments of the disclosure, the operation S1 described above specifically includes the following operations.

At S11, the compression roller 4 is controlled to rotate along a second rotation direction B, and when the compression roller 4 moves to the position directly below the drum 3, the compression roller 4 is stopped to rotate around the drum 3.

At S12, the drum 3 is controlled to rotate along the second rotation direction B.

In an example, as shown in FIG. 6D, before starting the operation S11, the compression roller 4 is located in a position directly above the drum 3, and the joint 51 of the conveyor belt fully extends beyond the two flat cutters 1. At this time, as shown in FIG. 6E, the compression roller 4 is controlled to rotate towards the position directly below the drum 3 around the drum 3 along the second rotation direction B. The compression roller 4 is stopped to rotate when the compression roller 4 moves to the position directly below the drum 3. If the compression roller 4 continues to rotate around the drum 3 along the second rotation direction B and exceeds the position directly below the drum 3, the movement trajectory of the conveyor belt 5 will be no longer smooth, and the conveyor belt 5 will be bent by an angle at the compression roller 4. In this way, the conveyor belt 5 exerts a pressure to the compression roller 4 during the movement of the conveyor belt 5, which may increase the operation load of the compression roller 4 and may reduce the service life of the compression roller 4. Then, the drum 3 is controlled to rotate along the second rotation direction B. As shown in FIG. 6F, at this time, the compression roller 4 stays in the position directly below the drum 3 and rotates about its axis, to allow the joint 51 of the conveyor belt to be driven to move along the blade of each of the two flat cutters 1 by the drum 3, and to allow the rubber layer located at the joint 51 of the conveyor belt to be cut off by each of the two flat cutters 1. A state in which the rubber layer located at the joint 51 of the conveyor belt has been cut off by each of the two flat cutters 1 is shown in FIG. 6G. It should be noted that the second rotation direction B is a direction opposite to the first rotation direction A.

On this basis, before the operation S3a4 described above, the method further includes the following operation.

At S3a31, the drum 3 is controlled to rotate along the first rotation direction A and the compression roller 4 is controlled to rotate around the drum 3 along the first rotation direction A, to allow the conveyor belt 5 to move toward the two forming cutters 2, and when the compression roller 4 moves to the position directly above the drum 3, the compression roller 4 is stopped to rotate around the drum 3.

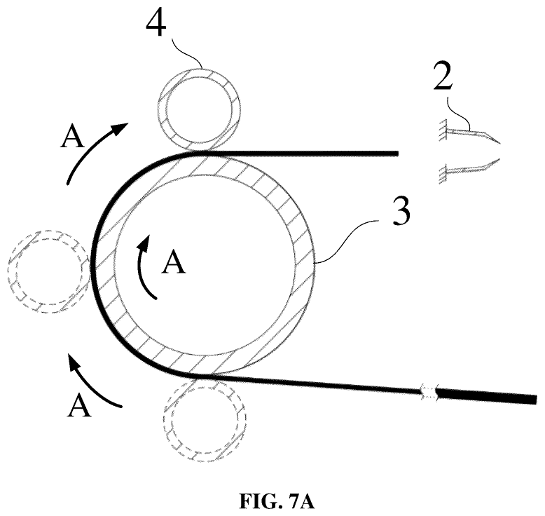

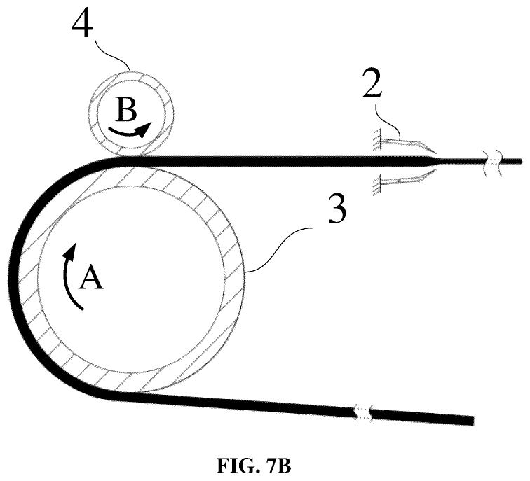

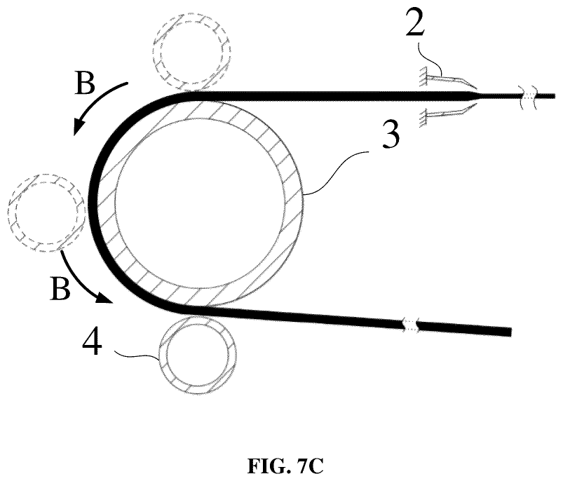

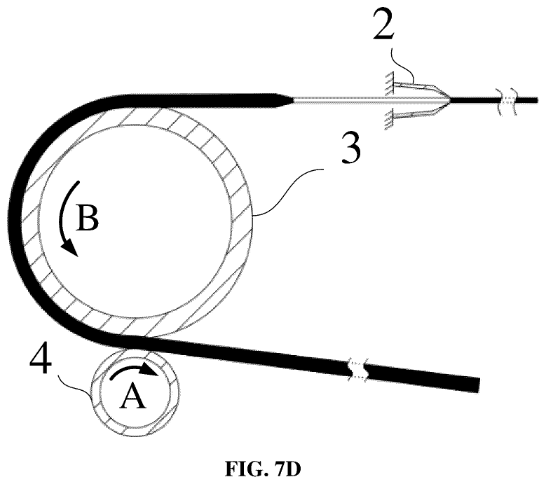

At this time, the two flat cutters 1 located at the target position has been replaced with the two forming cutters 2, and it is necessary to control the conveyor belt 5 to perform a repetitive movement similar to the operation that the rubber layer of the conveyor belt 5 is cut off by each of the two flat cutters 1. Specifically, with reference to FIG. 7A, FIG. 7B, FIG. 7C and FIG. 7D, first, the compression roller 4 and the drum 3 are controlled to rotate along the first rotation direction A. The compression roller 4 is stopped to rotate around the drum 3 when the compression roller 4 moves to the position directly above the drum 3, as shown in FIG. 7A. Then, the drum 3 is controlled to continue to move along the first rotation direction A, to allow the joint 51 of the conveyor belt to fully extend beyond the two forming cutters 2, as shown in FIG. 7B.

On this basis, in some embodiments of the disclosure, the operation S3 described above specifically includes the following operations.

At S31, the compression roller 4 is controlled to rotate along the second rotation direction B, and when the compression roller 4 moves to the position directly below the drum 3, the compression roller 4 is stopped to rotate around the drum 3.

At S32, the drum 3 is controlled to rotate along the second rotation direction B.

For example, as shown in FIG. 7B, before starting the operation S31, the compression roller 4 is located in the position directly above the drum 3, and the joint 51 of the conveyor belt fully extends beyond the two forming cutters 2. At this time, the compression roller 4 is controlled to rotate along the second rotation direction B until the compression roller 4 moves to the position directly below the drum 3. Then, the compression roller 4 is stopped to rotate along the second rotation direction B, as shown in FIG. 7C.

Then, the drum 3 is controlled to rotate along the second rotation direction B. As shown in FIG. 7D, the compression roller 4 stays in the position directly below the drum 3 and rotates about its axis, to allow the joint 51 of the conveyor belt to be driven to move along the blade of each of the two forming cutters 2 by the drum 3, and to allow the rubber layer between the plurality of steel wire rope cores 52 located at the joint 51 of the conveyor belt to be cut off along the width direction of the joint 51 of the conveyor belt by each of the two forming cutters 2. It should be noted that the second rotation direction B is a direction opposite to the first rotation direction A. As shown in FIG. 7C, the second rotation direction B is a counterclockwise direction.

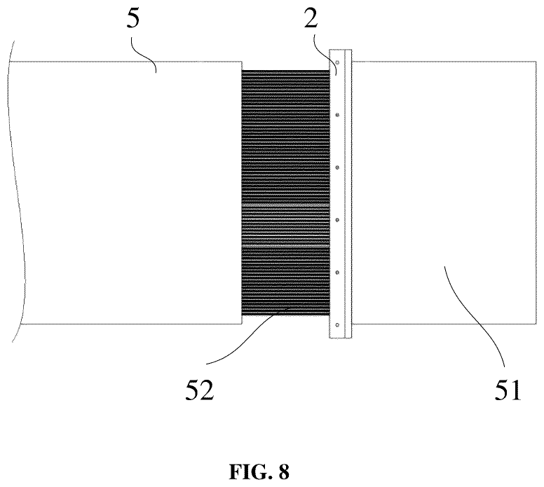

In an example, FIG. 8 shows a schematic diagram illustrating an operation that the rubber layer located at the joint 51 of the conveyor belt is cut off by each of the two forming cutters 2.

The sequence numbers of the embodiments of the disclosure are adopted for description only and do not represent the advantages and disadvantages of the embodiments. The above are only the preferred embodiments of the disclosure and not intended to limit the scope of protection of the disclosure. Any equivalent structure or equivalent flow transformation made by using the contents of the description and drawings of the disclosure, or any equivalent structure or equivalent flow transformation directly or indirectly applied to other related technical fields, are equally included within the scope of protection of the disclosure.

### INDUSTRIAL APPLICABILITY

In a method for separating a plurality of steel wire rope cores of a conveyor belt according to the embodiments of the disclosure, each of a blade of at least one flat cutter and a blade of at least one forming cutter has a dimension along a width direction of the conveyor belt greater than a width of the conveyor belt. In this way, a rubber layer on each of two sides of each of the plurality of steel wire rope cores of the conveyor belt is cut off once along a thickness direction of the conveyor belt by the at least one flat cutter, and a rubber layer between the plurality of steel wire rope cores of the conveyor belt is cut off once along a width direction of the conveyor belt by the at least one forming cutter. In this way, the operation efficiency of the separation of the plurality of steel wire rope cores of the conveyor belt is improved by the method for separating the plurality of steel wire rope cores of the conveyor belt according to the embodiments of the disclosure, thus the problems of the high labor intensity and the long time consumption caused by the separation of the plurality of steel wire rope cores located at a joint of the conveyor belt are solved.

1. A method for separating a plurality of steel wire rope cores of a conveyor belt, comprising:
controlling the conveyor belt to move to allow a joint of the conveyor belt to move along at least one flat cutter;
cutting off a rubber layer on each of two sides of each of the plurality of steel wire rope cores located at the joint of the conveyor belt along a first direction by the at least one flat cutter;
controlling the conveyor belt to move to allow the joint of the conveyor belt to move along at least one forming cutter; and
cutting off a rubber layer between the plurality of steel wire rope cores located at the joint of the conveyor belt along a second direction by the at least one forming cutter,
wherein the first direction is a thickness direction of the conveyor belt, the second direction is a width direction of the conveyor belt, a blade of the at least one flat cutter is provided as a linear type, a blade of the at least one forming cutter is provided with a plurality of semicircular cutting edges, a spacing between every two adjacent semicircular cutting edges of the plurality of semicircular cutting edges is equal to a spacing between every two adjacent steel wire rope cores of the plurality of steel wire rope cores of the conveyor belt, and each of the blade of the at least one flat cutter and the blade of the at least one forming cutter has a dimension along the second direction greater than a width of the conveyor belt.

2. The method for separating the plurality of steel wire rope cores of the conveyor belt according to claim 1, wherein the method, before controlling the conveyor belt to move to allow the joint of the conveyor belt to move along the at least one flat cutter, further comprises a first preparation operation, the first preparation operation comprising:
arranging two flat cutters symmetrically along the first direction at a target position;
adjusting a gap between the two flat cutters to be greater than a thickness of the conveyor belt;
controlling the conveyor belt to move to allow the joint of the conveyor belt to extend beyond the two flat cutters; and
adjusting the gap between the two flat cutters to be equal to a diameter of each of the plurality of steel wire rope cores.

3. The method for separating the plurality of steel wire rope cores of the conveyor belt according to claim 2, wherein arranging the two flat cutters symmetrically along the first direction at the target position in the first preparation operation further comprises:
allowing a direction of extension of each of the two flat cutters to be parallel to the second direction.

4. The method for separating the plurality of steel wire rope cores of the conveyor belt according to claim 2, wherein adjusting the gap between the two flat cutters to be equal to the diameter of each of the plurality of steel wire rope cores in the first preparation operation further comprises:
adjusting a position of each of the two flat cutters to allow the joint of the conveyor belt to move linearly along the blade of each of the two flat cutters.

5. The method for separating the plurality of steel wire rope cores of the conveyor belt according to claim 2, wherein the at least one flat cutter and the at least one forming cutter are arranged at a same target position, wherein after cutting off the rubber layer on each of the two sides of each of the plurality of steel wire rope cores located at the joint of the conveyor belt along the first direction by the at least one flat cutter, the at least one flat cutter is replaced with the at least one forming cutter, and wherein the method, before controlling the conveyor belt to move to allow the joint of the conveyor belt to move along the at least one forming cutter, further comprises a second preparation operation, the second preparation operation comprising:
removing the two flat cutters at the target position;
arranging two forming cutters symmetrically along the first direction at the target position;
adjusting a gap between the two forming cutters to be greater than the thickness of the conveyor belt;
controlling the conveyor belt to move to allow the joint of the conveyor belt to extend beyond the two forming cutters; and
adjusting the gap between the two forming cutters to be equal to the diameter of each of the plurality of steel wire rope cores.

6. The method for separating the plurality of steel wire rope cores of the conveyor belt according to claim 5, wherein controlling the conveyor belt to move comprises controlling the conveyor belt to move by a drum and a compression roller, the drum is rotatable about an axis of the drum, and the compression roller is rotatable about an axis of the compression roller and is rotatable around the roller between a position directly above the roller and a position directly below the roller.

7. The method for separating the plurality of steel wire rope cores of the conveyor belt according to claim 6, wherein the method, before controlling the conveyor belt to move to allow the joint of the conveyor belt to extend beyond the two flat cutters in the first preparation operation, further comprises:
controlling the compression roller to move to allow the compression roller to move to the position directly below the drum;
compressing the joint of the conveyor belt between the drum and the compression roller; and
controlling the drum to rotate along a first rotation direction and controlling the compression roller to rotate around the drum along the first rotation direction, to allow the conveyor belt to move toward the two flat cutters, and stopping the compression roller to rotate around the drum when the compression roller moves to the position directly above the drum.

8. The method for separating the plurality of steel wire rope cores of the conveyor belt according to claim 7, wherein controlling the conveyor belt to move to allow the joint of the conveyor belt to move along the at least one flat cutter comprises:
controlling the compression roller to rotate along a second rotation direction, and stopping the compression roller to rotate around the drum when the compression roller moves to the position directly below the drum; and
controlling the drum to rotate along the second rotation direction.

9. The method for separating the plurality of steel wire rope cores of the conveyor belt according to claim 8, wherein the method, before controlling the conveyor belt to move to allow the joint of the conveyor belt to extend beyond the two forming cutters in the second preparation operation, further comprises:
controlling the drum to rotate along the first rotation direction and controlling the compression roller to rotate around the drum along the first rotation direction, to allow the conveyor belt to move toward the two forming cutters, and stopping the compression roller to rotate around the drum when the compression roller moves to the position directly above the drum.

10. The method for separating the plurality of steel wire rope cores of the conveyor belt according to claim 9, wherein controlling the conveyor belt to move to allow the joint of the conveyor belt to move along the at least one forming cutter comprises:
controlling the compression roller to rotate along the second rotation direction, and stopping the compression roller to rotate around the drum when the compression roller moves to the position directly below the drum; and
controlling the drum to rotate along the second rotation direction.
